(19) United States
(12) Patent Application Publication
(10) Pub. No.: US 2022/0036045 A1
(43) Pub. Date: Feb. 3, 2022

(54) IMAGE PROCESSING SYSTEM

(71) Applicant: SK hynix Inc., Gyeonggi-do (KR)

(72) Inventors: Taehee Cho, Gyeonggi-do (KR); Kwang June Sohn, Gyeonggi-do (KR); Ik Seok Yang, Gyeonggi-do (KR); Kwang Jun Cho, Gyeonggi-do (KR)

(21) Appl. No.: 17/142,464

(22) Filed: Jan. 6, 2021

(30) Foreign Application Priority Data
Jul. 30, 2020 (KR) 10-2020-0095045

(51) Int. Cl. G06K 9/00; G06K 9/20; G06K 9/62

(52) U.S. Cl. CPC G06K 9/00281; G06K 9/6202; G06K 9/00335; G06K 9/2054

(57) ABSTRACT

An image processing system includes an image sensor suitable for performing an operation in a first mode to generate an image of a first quality and performing an operation in a second mode to generate an image of a second quality which is higher than the first quality; an auxiliary processor suitable for processing the image of the first quality generated by the image sensor in the first mode; and a main processor suitable for processing the image of the second quality generated by the image sensor in the second mode.

### CROSS-REFERENCE TO RELATED APPLICATIONS

The present application claims the benefit of and priority to Korean Patent Application No. 10-2020-0095045, filed on Jul. 30, 2020, which is incorporated herein by reference in its entirety.

### BACKGROUND

### 1. Field

Various embodiments of the present disclosure relate to an image processing system.

### 2. Description of the Related Art

The field of biometrics includes facial recognition technology, which is a technology in which a machine automatically identifies and authenticates a person by using unique feature information of a person's face.

A face recognition is widely used for the purpose of unlocking portable devices, such as smart phones, and computer devices. In order to use the face recognition function for this purpose, an image sensor capable of recognizing the person's face should be always turned on, causing high current consumption. Therefore, there is a need for a technology capable of reducing the amount of current consumption the image sensor and its accompanying circuits while always being able to recognize a person's face.

### SUMMARY

Embodiments of the present disclosure are directed to an image processing system capable of recognizing a face or a gesture while consuming a small amount of current.

In accordance with an embodiment of the present disclosure, an image processing system includes: an image sensor suitable for performing an operation in a first mode to generate an image of a first quality and performing an operation in a second mode to generate an image of a second quality which is higher than the first quality; an auxiliary processor suitable for processing the image of the first quality generated by the image sensor in the first mode; and a main processor suitable for processing the image of the second quality is generated by the image sensor in the second mode.

In accordance with another embodiment of the present disclosure, an image processing system includes: an image sensor suitable for performing an operation in a first mode to generate an image of a first quality and performing an operation in a second mode to generate an image of a second quality which is higher than the first quality; and a processor suitable for processing an image generated by the image sensor, wherein the processor consumes more current in the second mode than in the first mode, and wherein when a presence of a face is detected as a result of processing the image of the first quality which is generated by the image sensor in the first mode, an operation mode of the image sensor is switched from the first mode to the second mode.

In accordance with yet another embodiment of the present disclosure, an image processing system includes: an image sensor suitable for performing an operation in a first mode to generate an image of a first quality and performing an operation in a second mode to generate an image of a second quality which is higher than the first quality; and a processor suitable for processing an image generated by the image sensor, wherein the processor consumes more current in the second mode than in the first mode, and wherein when a presence of a gesture is detected as a result of processing the image of the first quality which is generated by the image sensor in the first mode, an operation mode of the image sensor is switched from the first mode to the second mode.

in accordance with still yet another embodiment of the present disclosure, a method for recognition a face or gesture in an image processing system, the method includes: identifying a presence of a face or gesture based on an image generated by an image sensor in a first mode; switching the image processing system from the first mode to a second mode, when the identifying operation is successful; authenticating an identification of the face or recognizing one of predetermined gestures based on an image generated by the image sensor in the second mode; and unlocking the image processing system when the authenticating or recognizing operation is successful, wherein a current consumption used for generating the image in the first mode is lower than that used for generating the image in the second mode.

### BRIEF DESCRIPTION OF THE DRAWINGS

FIG. 1 is a block diagram illustrating an image processing system 100 in accordance with an embodiment of the present disclosure.

FIG. 2 illustrates a table describing first to third modes.

FIG. 3 is a diagram illustrating how an operation mode is switched in the image processing system 100 of FIG. 1.

FIG. 4 is a block diagram illustrating the image sensor 110 shown in FIG. 1.

FIG. 5 is a block diagram illustrating an image processing system 500 in accordance with another embodiment of the present disclosure.

### DETAILED DESCRIPTION

Various embodiments of the present disclosure will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present disclosure.

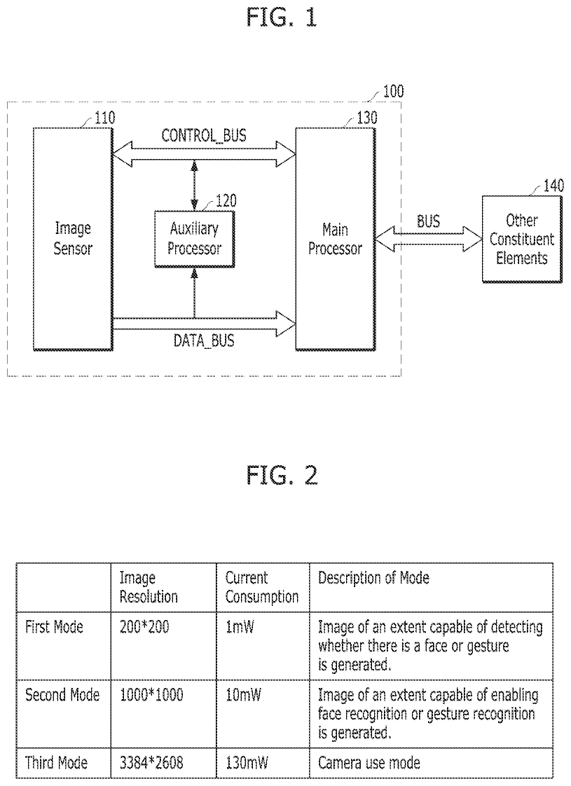

FIG. 1 is a block diagram illustrating an image processing system 100 in accordance with an embodiment of the present disclosure.

Referring to FIG. 1, the image processing system 100 may include an image sensor 110, an auxiliary processor 120, and a main processor 130.

The image sensor 110 may generate an image by converting light received through a lens into digital signals. The image sensor 110 may have three operation modes, a first operation mode, a second operation mode and a third operation mode. However, the image sensor is not limited to the three modes, and a greater number or a lesser number of modes may be used. In an embodiment, the first mode may be a low power mode. In the first mode, the image sensor 110 may consume the least amount of current to generate an image of the lowest quality, for example, lowest resolution. The second mode may he a mid-power mode. In the second mode, the image sensor 110 may consume more current than in the first mode to generate an image of a higher quality than that of the first mode. The third mode may be a high power mode. In the third mode, the image sensor 110 may consume more current than in the second mode to generate an image of a higher quality than that of the second mode.

FIG. 2 is a table describing the first, second and third modes.

Referring to FIG. 2, as an example in the first mode, it may be seen that the image generated by the image sensor 110 has a resolution of approximately 200*200 and the image sensor 110 consumes approximately 1 mW of current. However, other resolutions and currents may be used in the first mode. As an example, in the second mode, it may be seen that the image generated by the image sensor 110 has a resolution of approximately 1000*1000 and consumes approximately 10 mW of current. However, other resolutions and currents may be used in the second mode. Lastly, as an example, in the third mode, it may be seen that the image generated by the image sensor 110 has a resolution of approximately 3384*2608 and consumes approximately 130 mW of current. However other resolutions and currents may be used in the third mode. As described in FIG. 2, in the first mode, an image that enables checking whether there is a face or gesture may be generated. In other words, in the first mode, an image of an extent only capable of distinguishing whether a face or gesture to perform a recognition operation exists or not, and an image of an extent capable of enabling face recognition or gesture recognition may not be generated. In the second mode, an image of an extent capable of performing a face recognition operation or a gesture recognition operation may be generated. The third mode may be a mode in which a user uses a camera, for example, a mode in which the user takes a picture. In this mode, the image sensor 110 may exhibit its maximum performance. The numbers in FIG. 2 are only examples for relative expression, and it is obvious to those skilled in the art to which the present invention pertains that these numbers may be different from the example of FIG. 2. Although the embodiment describes a face or a gesture recognition, the image sensor 110 may apply to various other recognition technologies and is not limited to face or a gesture.

The auxiliary processor 120 may control the image sensor 110 to process an image generated by the image sensor 110 in the first mode. The auxiliary processor 120 may have sufficient processing power to determine whether or not a face or a gesture is included in the image generated by the image sensor 110 in the first mode, but may not have sufficient processing power to perform a face recognition operation or a gesture recognition operation. Since the processing power of the auxiliary processor 120 is low, the current consumption of the auxiliary processor 120 may be maintained at a low level. A control bus CONTROL_BUS may be a bus for controlling the image sensor 110, and a data bus DATA_BUS may be a bus for transferring image data generated by the image sensor 110 to the auxiliary processor 120 in the first mode. When the presence of a face is detected by the auxiliary processor 120 or the presence of a gesture is detected by the auxiliary processor 120, the operation mode of the image sensor 110 may be changed from the first mode to the second mode.

The main processor 130 may control the image sensor 110 in the second mode. In the second mode, the main processor 130 may perform a face recognition operation or a gesture recognition operation based on an image generated by the image sensor 110. When a predetermined face, for example of a person, is recognized as a result of performing the face recognition operation, that is, when authentication for an identification of the person is successful, a system including the image processing system 100 may be unlocked. When the predetermined face is not recognized as a result of performing the face recognition operation, the main processor 130 may switch the operation mode of the image sensor 110 back to the IS first mode. When one gesture among predetermined gestures, for example of a person, is recognized as a result of performing the gesture recognition operation, the main processor 130 may control a system including the image processing system to perform an operation corresponding to the gesture. When none of the predetermined gestures are recognized as a result of performing the gesture recognition operation, the main processor 130 may switch the operation mode of the image sensor 110 back to the first mode. In an embodiment, when the image processing system 100 is included in a smart phone, the main processor 130 may be an application processor (AP) of the smart phone. In another embodiment, when the image processing system 100 is included in a personal computer (PC), the main processor 130 may be a Central Processing Unit (CPU) of the PC.

The main processor 130 may control the image sensor 110 in the third mode. The third mode may be a mode in which a camera is used upon receiving the instruction of a user, and in this case, the image sensor 110 may operate at the maximum performance.

Other constituent elements 140 may represent the constituent elements of a system including the image processing system 100. For example, when the image processing system 100 is included in the smart phone, the other constituent elements 140 may represent the constituent elements other than the image processing system 100 in the smart phone. Also, when the image processing system 100 is included in a PC, the other constituent elements 140 may represent the constituent elements other than the image processing system 100 in the PC. The bus BUS may be a bus for communication between the main processor 130 and the other constituent elements.

The constituent elements 110 to 130 of the image processing system 100 of FIG. 1 may be realized as one or more physical integrated circuit chips. For example, each of the constituent elements 110 to 130 may be fabricated as separate integrated circuit chips so that the image processing system 100 may consist of three integrated circuit chips. Additionally, both the image sensor 110 and the auxiliary processor 120 may be fabricated as a single integrated circuit chip and the main processor 130 may be fabricated as a single integrated circuit chip so that the image processing system 100 may consist of two integrated circuit chips. However, the image processing system 100 may consist of other numbers of integrated circuit chips instead of the two or three integrated circuit chips described above.

Although the face recognition operation and the gesture recognition operation of the image processing system 100 are described above, one of ordinary skill in the art will realize that the image processing system 100 may perform both of these operations or perform one of the operations.

Also described herein is an embodiment of the present disclosure being applied to a face recognition operation or a gesture recognition operation of the image processing system 100, but the present invention may be applied to general object recognition technology as well. In this case, in the first mode, an image capable of identifying a presence of an object may be generated, but an image capable of authenticating an identification of the object may not be generated. Further, in the second mode, an image capable of authenticating the identification of the object may be generated.

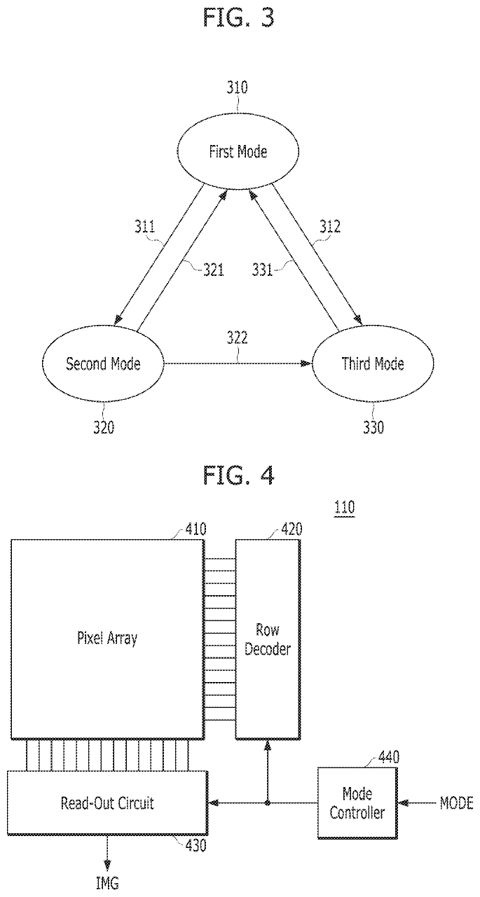

FIG. 3 is a diagram illustrating how an operation mode is switched in the image processing system 100 of FIG. 1.

In the first mode 310, the image sensor 110 may operate with a low power, and the auxiliary processor 120 may control the image sensor 110 to process the image of the image sensor 110. In the first mode 310, it may be detected whether a face exists in order to perform a facial recognition operation or whether a gesture exists in order to perform a gesture recognition operation. That is, in the first mode, an operation for determining whether or not the image processing system 100 needs to perform a recognition operation may be performed. In a state where the image processing system 100 is not actively used (e.g., in a stand-by state), the image processing system 100 may be maintained in the first mode 310. When it is determined that there is a face or gesture to perform a recognition operation during the operation of the first mode 310, the operation mode of the image processing system 100 may be switched from the first mode 310 to the second mode 320 (311). Moreover, when a user operates a camera function during the operation of the first mode 310, the operation mode of the image processing system 100 may be switched from the first mode 310 to the third mode 330 (312). In the first mode 310, the image sensor 110 may generate an image at low frames per second (fps).

In the second mode 320, the image sensor 110 may operate at a mid-power (for example, higher power than first mode but lower power than third mode), and the main processor 130 may control the image sensor 110 to process the image of the image sensor 110. In the second mode 320, a face recognition operation or a gesture recognition operation may be performed. When a predetermined face is recognized as a result of performing the face recognition operation, that is, when authentication for an identification of the person is successful, the image processing system 100 and a system including the image processing system 100 (e.g., a smart phone, a PC, etc.) may be unlocked. When the predetermined face is not recognized as a result of performing the face recognition operation, the image processing system 100 may not be unlocked. Regardless of whether the authentication is successful or not, the operation mode of the image sensor 100 may be switched from the second mode to the first mode after the face recognition operation is completed (321). When one gesture among predetermined gestures is recognized as a result of performing the gesture recognition operation, the image processing system may perform an operation corresponding to the recognized gesture. After the gesture recognition operation is completed, the operation mode of the image sensor 100 may be switched from the second mode to the first mode (321). Also, when a user operates a camera function during the operation of the second mode 320, the operation mode of the image processing system 100 may be switched from the second mode 320 to the third mode 330 (322). In the second mode 320, the image sensor 110 may generate an image at higher frames per second (fps) than the first mode 310.

In the third mode 330, the image sensor 110 may operate at a high power (for example, higher power than the second mode), and the main processor 130 may control the image sensor 110 to process the image of the image sensor 110. In the third mode 330, the image processing system may execute a camera function requested by a user. When the operation of the third mode 330 is completed, that is, after all the operations requested by the user are performed, the operation mode of the image processing system 100 may be switched from the third mode 330 to the first mode 310 (331). When it is required to perform a face recognition operation or a gesture recognition operation during the operation of the third mode 330, the face recognition operation or the gesture recognition operation may be performed in the third mode 330 without changing the mode. In the third mode 330, since the image sensor 110 generates an image of a high quality and the main processor 130 processes the generated image, the face recognition operation or gesture recognition operation also can be performed. In the third mode 330, the image sensor is may generate an image at higher frames per second (fps) than the second mode 320.

Although not illustrated in FIG. 3, an operation mode of the image sensor 110 may include an idle mode. In this case, the image sensor 110 and the auxiliary processor 120 may be deactivated, and the operations for face recognition and gesture recognition may not be performed.

FIG. 4 is a block diagram illustrating the image sensor 110 shown in FIG. 1.

Referring to FIG. 4, the image sensor 110 may include a pixel array 410, a row decoder 420, a read-out circuit 430, and a mode controller 440.

The pixel array 410 may include a plurality of pixels that are arranged in a plurality of rows and a plurality of columns. The row decoder 420 may select pixels in the pixel array 410 for each row and generate signals for controlling the pixels of the selected row. The read-out circuit 430 may generate an image IMG based on pixel signals output from the pixels of a row selected by the row decoder 420 in the pixel array 410. The image IMG generated by the read-out circuit may be transmitted to the auxiliary processor 120 or the main processor 130 through a data bus DATA_BUS.

The mode controller 440 may control the operation mode of the image sensor 110. The image sensor 110 may generate an image IMG of different qualities according to the operation mode. The mode controller 440 may control a pixel binning operation or a pixel skipping operation to adjust the image qualities.

The mode controller 440 may control the row decoder 420 and the read-out circuit 430 not to perform a pixel binning operation and a pixel skipping operation in the third mode. Also, in the second mode, the mode controller may control the row decoder 420 and the read-out circuit 430 to perform at least one operation of the pixel binning operation and the pixel skipping operation. Also, in the first mode, the mode controller 440 may control the row decoder 420 and the read-out circuit 430 to perform the pixel-binning or pixel skipping operation on more pixels than in the second mode. For example, the mode controller 440 may control the row decoder 420 and the read-out circuit 430 not to perform the pixel binning operation in the third mode, but to perform the pixel binning operation on the basis of 4 pixels in the second mode or perform the pixel binning operation on the basis of 16 pixels in the first mode. A mode signal MODE may be a signal indicating which mode the auxiliary processor 120 or the main processor 130 sets. The mode signal MODE may be transferred to the mode controller 440 through the control bus CONTROL_BUS.

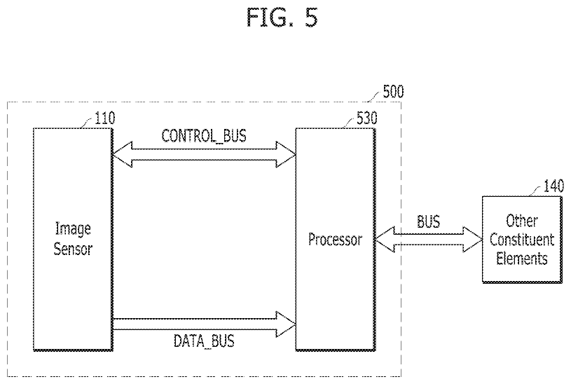

FIG. 5 is a block diagram illustrating an image processing system 500 in accordance with another embodiment of the present disclosure.

Referring to FIG. 5, the image processing system 500 may include an image sensor 110 and a processor 530.

In the image processing system 500 of FIG. 5, the auxiliary processor 120 and the main processor 130 may be integrated into a single processor 530. The processor 530 may operate in a first mode, a second mode, and a third mode, and its processing performance may be adjusted according to the mode. That is, the processor 530 may consume more current and have more powerful processing capability as it goes from the first mode to the third mode.

The image processing system 500 may operate in the same manner as the image processing system 100, except that the auxiliary processor 120 and the main processor 130 are integrated into the single processor 530.

According to embodiments of the present disclosure, an image processing system may be capable of recognizing a face or a gesture while consuming a small amount of current.

While the present invention has been described with respect to the specific embodiments, it will be apparent to those skilled in the art that various changes and modifications may be made without departing from the spirit and scope of the invention as defined in the following claims.

What is claimed is:

1. An image processing system, comprising:
an image sensor suitable for performing an operation in a first mode to generate an image of a first quality and performing an operation in a second mode to generate an image of a second quality which is higher than the first quality;
an auxiliary processor suitable for processing the image of the first quality generated by the image sensor in the first mode; and
a main processor suitable for processing the image of the second quality generated by the image sensor in the second mode.

2. The image processing system of claim 1, wherein when a presence of a face is detected by the auxiliary processor in the first mode,
an operation mode of the image processing system is switched from the first mode to the second mode.

3. The image processing system of claim 2, wherein in the second mode, the main processor performs a face recognition operation by using the image of the second quality generated by the image sensor.

4. The image processing system of claim 3, wherein the image sensor consumes less power in the first mode than in the second mode.

5. The image processing system of claim 3, wherein the image of the first quality has a lower resolution than the image of the second quality.

6. The image processing system of claim 3, wherein when a predetermined face is not recognized as a result of performing the face recognition operation by the main processor,
the operation mode of the image processing system is switched from the second mode to the first mode.

7. The image processing system of claim 3, wherein when a predetermined face is recognized as a result of performing the face recognition operation by the main processor,
the image processing system is unlocked.

8. The image processing system of claim 4, wherein the image sensor further performs an operation in a third mode for generating an image of a third quality which is higher than the second quality,
wherein the main processor processes the image of the third quality generated by the image sensor in the third mode, and
wherein the third mode is activated according to a user's command in the state of the image processing system being unlocked.

9. The image processing system of claim 1, wherein when a presence of a gesture is detected by the auxiliary processor in the first mode,
an operation mode of the image processing system is switched from the first mode to the second mode.

10. The image processing system of claim 9, wherein in the second mode, the main processor performs a gesture recognition operation by using the image of the second quality generated by the image sensor.

11. The image processing system of claim 10, wherein when one gesture among predetermined gestures is not recognized as a result of performing the gesture recognition operation by the main processor,
the operation mode of the image processing system is switched from the second mode to the first mode.

12. The image processing system of claim 10, wherein when one gesture among predetermined gestures is recognized as a result of performing the gesture recognition operation by the main processor,
the image processing system performs an operation corresponding to the recognized gesture.

13. The image processing system of claim 8, wherein the image sensor performs a pixel binning operation in the first mode and the second mode, and
wherein the number of pixels binned in the first mode is greater than the number of pixels binned in the second mode.

14. The image processing system of claim 8, wherein the image sensor performs a pixel skipping operation in the first mode and the second mode, and
wherein the number of pixels skipped in the first mode is greater than the number of pixels skipped in the second mode.

15. An image processing system, comprising:
an image sensor suitable for performing an operation in a first mode to generate an image of a first quality and performing an operation in a second mode to generate an image of a second quality which is higher than the first quality; and
a processor suitable for processing an image generated by the image sensor,
wherein the processor consumes more current in the second mode than in the first mode, and
wherein when a presence of a face is detected as a result of processing the image of the first quality which is generated by the image sensor in the first mode, an operation mode of the image sensor is switched from the first mode to the second mode.

16. The image processing system of claim 15, wherein in the second mode, the processor performs a face recognition operation by using the image of the second quality which is generated by the image sensor.

17. The image processing system of claim 15, wherein when a predetermined face is not recognized as a result of performing the face recognition operation,
the operation mode of the image sensor is switched from the second mode to the first mode.

18. The image processing system of claim 15, wherein when a predetermined face is recognized as a result of performing the face recognition operation,
the image processing system is unlocked.

19. An image processing system, comprising:
an image sensor suitable for performing an operation in a first mode to generate an image of a first quality and performing an operation in a second mode to generate an image of a second quality which is higher than the first quality; and
a processor suitable for processing an image generated by the image sensor,
wherein the processor consumes more current in the second mode than in the first mode, and
wherein when a presence of a gesture is detected as a result of processing the image of the first quality which is generated by the image sensor in the first mode, an operation mode of the image sensor is switched from the first mode to the second mode.

20. The image processing system of claim 19, wherein in the second mode, the processor performs a gesture recognition operation by using the image of the second quality which is generated by the image sensor.

21. The image processing system of claim 20, wherein when one gesture among predetermined gestures is not recognized as a result of performing the gesture recognition operation,
the operation mode of the image sensor is switched from the second mode to the first mode.

22. The image processing system of claim 20, wherein when one gesture among predetermined gestures is recognized as a result of performing the gesture recognition operation,
the image processing system performs an operation corresponding to the recognized gesture.

23. A method for recognizing a face or gesture in an image processing system, the method comprising,
identifying a presence of a face or gesture based on an image generated by an image sensor in a first mode;
switching the image processing system from the first mode to a second mode, when the identifying operation is successful;
authenticating an identification of the face or recognizing one of predetermined gestures based on an image generated by the image sensor in the second mode; and
unlocking the image processing system when the authenticating or recognizing operation is successful,
wherein a current consumption used for generating the image in the first mode is lower than that used for generating the image in the second mode.
